(19) United States
(12) Patent Application Publication
(10) Pub. No.: US 2012/0027212 A1
(43) Pub. Date: Feb. 2, 2012

(54) METHOD FOR DETERMINING A CHAIN OF KEYS, METHOD FOR TRANSMITTING A PARTIAL CHAIN OF THE KEYS, COMPUTER SYSTEM AND CHIP CARD

(75) Inventor: Christoph Ruland, Siegen (DE)

(73) Assignee: SECUTANTA GMBH, Siegen (DE)

(21) Appl. No.: 13/124,080

(22) PCT Filed: May 4, 2009
(86) PCT No.: PCT/EP09/55350

§ 371 Date: Oct. 7, 2011

(30) Foreign Application Priority Data
May 2, 2008 (DE) 10 2008 021 933.9

(51) Int. Cl. H04L 9/08; H04L 9/06

(52) U.S. Cl. 380/278; 380/45

(57) ABSTRACT

The invention relates to a security module comprising
an interface (596) for receiving a first key of a first chain (400) and a second key of a second chain (402), wherein a predecessor key can be calculated from each successor key of the first chain by applying a first function, wherein the first function is a one-way function, wherein the second chain can be determined by iteratively applying a second function, wherein the second function is a one-way function,
a processor (569) for executing program instructions (555), wherein, by executing the program instructions, the first keys of a first partial chain (408, 408′, . . . ) of the first chain are calculated by iteratively applying the first function beginning with the received first key, and second keys of a second partial chain (410, 410′, . . . ) of the second chain are calculated by iteratively applying the second function beginning with the received second key, and a partial chain (406, 406′, . . . ) of a resulting chain (404) is determined from the first and second partial chains,
a nonvolatile protected first memory (566) for storing the determined keys of the resulting chain.

The invention relates to a security module, in particular a smart card, a tamper-proof module (TPM) or a USB stick, and an electronic device comprising a conditional access module (CAM), in particular for decoding a digital audio and/or video transmission, such as e.g. a unicast, multicast or broadcast audio and/or video signal, in particular a television signal.

In particular, the invention relates to a method for determining a resulting chain of keys, a method for transmitting a partial chain of the resulting chain of keys, a method for receiving a partial chain of the resulting chain of keys, and corresponding computer program products, a computer system and an electronic device, in particular a security token, such as e.g. a smart card, SIM card or an RFID tag.

The use of cryptographic keys for a variety of purposes is known from the prior art. In particular, cryptographic keys serve for protecting information, files or programs against unauthorized access or unauthorized use, or they serve as proof of authorization for the utilization of a service, access to a protected area or for other authentication purposes. This use of cryptographic keys presupposes the distribution and management of the keys, which are generally designated as “key management”.

US 2007/0127719 A1 discloses a method for the key management of cryptographic keys. A one-way trapdoor function is used for generating cryptographic keys, said function being applied iteratively. A chain of cryptographic keys is generated as a result. What is disadvantageous in this case is that a receiver of a key of said chain can calculate all keys in the chain which precede said key, as a result of which the receiver acquires access even to those keys with respect to which said receiver is not even authorized.

According to embodiments of the invention, a security module is provided which makes it possible to determine keys of a resulting chain, for example in order to decrypt subscription files or a digital audio and/or video transmission, such as e.g. of a unicast, multicast or broadcast audio and/or video signal, in particular of a television signal. In this case, it is particularly advantageous that the security module makes it possible to resume a subscription, for example for procuring the files or the audio and/or video transmission, without thereby enabling a user to decrypt files or a previous audio and/or video transmission associated with a period of time in which the subscription had been interrupted.

According to embodiments of the invention, a “security module” is understood to be any module, such as e.g. a smart card, a tamper-proof module (TPM) or a USB stick, which, by means of internal or external measures, is protected against impermissible read-out or modification of information, in particular secret or private keys. This is intended to ensure that no unauthorized access to a secret and/or private key stored in the module can take place.

According to embodiments of the invention, the security module has a first memory for storing the first and second partial chains, wherein the first memory and/or the program instructions are/is embodied such that after a read access to first and second keys stored in the first memory and storage of the partial chain of the resulting chain in a second nonvolatile, protected memory, the content of the memory is erased.

By way of example, it is possible to use a first memory whose memory content is automatically erased in the event of a read access. In particular, the first memory can be embodied as a nonvolatile random access (NVRAM) memory, for example as a ferroelectric random access memory (FRAM) or magnetoresistive random access (MRAM) or phase-change random access (PRAM) memory.

The use of an FRAM memory is particularly advantageous. An FRAM memory is not a volatile memory, rather it retains its content even without a supply voltage. In this type of memory, the properties of ferroelectric substances are used for storing information. One essential feature of FRAM memories is that in the process of reading FRAM cells, the content thereof is erased. This means that after data have been read from the FRAM, said data are no longer present in the FRAM. This means here that on account of the reading of the first and second keys as a result of the execution of the program instructions from the FRAM memory, said keys are erased from the FRAM memory and are temporarily stored in the RAM of the processor in order to calculate the resulting keys.

According to embodiments of the invention, a method for determining a resulting chain of keys is provided. The method comprises the following steps: determining a first chain of first keys, wherein a predecessor key can be calculated from each successor key of the first chain by applying a first function, wherein the first function is a one-way trapdoor function or a one-way function; determining a second chain of second keys by iteratively applying a second function, wherein the second function is likewise a one-way trapdoor function or a one-way function, wherein each key of the resulting chain can be determined from in each case a first key of the first chain and a second key of the second chain.

According to embodiments of the invention, in order to generate the first chain therefore proceeding from a predefined start key of the first chain i.e. the first predecessor key, the first successor key is determined. The first successor key then serves as a predecessor key for determining a further successor key, etc., to an end key of the first chain. The direction from the start key to the end key of a chain is defined hereinafter as the “forward direction”.

The first chain is also designated as forward chain, and the second chain as backward chain. The forward chain serves to limit the possibility for deriving keys of the resulting chain in the forward direction, whereas the backward chain can limit the possibility for deriving keys of the resulting chain in the backward direction.

The number of successor keys until the end key is reached can be indefinite if it is assumed that the entity, i.e. the control center, which generates the first and second chains can extend these chains further and further as required.

The resulting chain of keys is therefore determined with the aid of the first and second chains. The first chain has the property that each predecessor key in the first chain can be calculated from its successor key, namely by a predefined first function. By contrast, the second chain has the property that each successor key can be calculated from its predecessor key, to be precise with the aid of a predefined second function.

A “one-way function” is understood here to be any function whose inverse function cannot be calculated or can be calculated only with very high computational complexity. If a one-way function is used in the case of the first function, the side that determines the keys has so much computing capacity that it can execute the inverse function; it is assumed, however, that the subscribers are not able to do this.

The resulting chain of keys is defined or generated with the aid of the first and second chains. By way of example, each key of the resulting chain is determined by a key of the first chain and a key of the second chain being combined with one another in a predefined manner, for example, by the two keys being attached to one another, i.e. concatenated, by the two keys being subjected to a logical and/or arithmetic operation, which can in turn include a further key, for example a bit-by-bit exclusive-OR (XOR) operation, or by a function value of a one-way function, for example the function value of a one-way hash function, being determined from the two keys. Said one-way hash function can be initialized with a secret value, for example. In this case, the selection of at least one key from the first chain and at least one key from the second chain for determining a key of the resulting chain can be made in the order given by the chains or according to another predefined scheme.

Embodiments of the invention are particularly advantageous since they enable a particularly effective key management for the distribution of cryptographic keys. This is because transmitting a partial chain of the resulting chain of keys to a subscriber merely necessitates transmitting to the subscriber one of the keys of the second chain, which key has been used for example for determining the start key of the resulting partial chain, and a key of the first chain, which key has been used for example for determining the end key of the resulting partial chain.

According to one embodiment of the invention, the first and/or the second function are/is a cryptographic HASH function, an RSA operation, an operation of the Rabin method, or an operation of a method based on the discrete logarithm problem.

In the case of the second function, the latter is used only in the forward direction, that is to say for calculating a key Eᵢ₊₁ from the preceding key Eᵢ in the second chain; if necessary, a public key associated with the second function can be used for this purpose.

The “resulting partial chain” is understood here to be a defined section of the resulting chain, wherein the defined section comprises keys determined for one or a plurality of subscribers, when the defined section begins with a start key and ends with an end key.

This is substantiated by the fact that the subscriber can calculate all predecessor keys of the received key in the first chain from the received key of the first chain by applying the first function. On the other hand, the subscriber can calculate all successor keys of the received key in the second chain from the received key of the second chain by applying the second function. However, the subscriber nevertheless only acquires knowledge of the partial chain of the resulting keys since said subscriber cannot calculate any predecessor keys of the received key of the second chain nor any successor keys of the received key of the first chain.

By combining the mutually assigned keys of the first and second chains, it is then possible for the keys of the resulting partial chain to be calculated at the subscriber end. In particular, it is advantageous in this case that, at the subscriber end, there is no possibility of also determining keys of the resulting chain which are predecessor keys with respect to the start key of the partial chain.

According to one embodiment of the invention, the first function is a one-way function. In this case, in order to generate the first chain proceeding from a start key of the first chain, a successor key has to be determined such that the start key is again produced by applying the one-way function. This correspondingly holds true for the keys of the first chain which follow the start key.

In the case of a one-way function, a successor key can be found such that, for example, according to a random method candidates for successor keys are generated, which are then subsequently checked to the effect of whether they result in the predecessor key when the one-way function is applied. As soon as such a successor key has been found, it becomes the predecessor key for which a successor key is again sought.

The method for finding the successor key with the aid of a one-way function has to require so much computing capacity that this is possible only for the computer system that serves for key generation. By way of example, said computer system is a key generating control center with great computing power. Since such great computing power is not usually available to the subscribers, the latter cannot find the successor keys using the method described above.

By way of example, the key generating control center is operated by a provider in order to supply encrypted content to the subscribers.

According to one embodiment of the invention, the first function is a one-way trapdoor function.

A “one-way trapdoor function” is understood here to be a special case of a one-way function. The inverse function of a one-way trapdoor function cannot be calculated or can be calculated only by considerable complexity, as is also the case for a one-way function, unless one has knowledge of the so-called “trapdoor”.

The “trapdoor” is a secret that enables the inverse function of the one-way trapdoor function to be calculated without great complexity. This makes it possible to generate the first chain with low complexity, since, for each predecessor key, the successor key can be calculated with the aid of the inverse function of the one-way trapdoor function, since the “trapdoor” is known to the generator of the chains.

By way of example, the “trapdoor” is a private key of an asymmetrical key pair. Said private key is known only to the generator of the resulting chain of keys. By way of example, the private key is stored in a protected memory area of a smart card or in a so-called secure computing platform, such that read-out is not possible.

Only with knowledge of the private key, therefore, is it possible for a generator of the first chain to calculate the keys of the first chain proceeding from a start key by means of the inverse function of the one-way trapdoor function with low complexity. A receiver of a key of the first chain cannot calculate the successor key of the received key of the first chain, since the receiver has no knowledge of the “trapdoor”, that is to say the private key. However, the receiver can calculate, from a received key of the first chain, the predecessor key thereof by applying the one-way trapdoor function, since this does not require knowledge of the trapdoor.

By way of example, the one-way trapdoor function is an RSA operation (modular exponentiation with specific requirements made of the parameters), as is known per se for the generation and verification of digital signatures (cf., for example, R. Rivest, A. Shamir, and L. Adleman, “A method for obtaining digital signatures and public key cryptosystems”, in Communications of the ACM, vol. 21, no. 2, 1978, pp. 120-126).

At the generator end, therefore, the RSA operation with the aid of the private key is used in order to realize the inverse function in this way, and to calculate a successor key for each predecessor key in the first chain. At the receiver end, conversely, a predecessor key of the first chain can be calculated from each successor key, to be precise with the aid of the RSA operation and the public key, whereby the function is realized.

For the generation of the first and second chains it is also possible to use respectively different key systems. By way of example, e₁, d₁, n₁ are used for the first chain and e₂, d₂, n₂ are used for the second chain, wherein preferably at least (d₁, n₁) and (d₂, n₂) are different.

According to one embodiment of the invention, the first function is a Rabin function, cf. M. O. Rabin, “Digitalized signatures”, in Foundations of Secure Computation, R. Lipton and R. D. Millo, Eds. New York: Academic Press, 1978, pp. 155-166.

Alternatively, it is also possible to use other one-way trapdoor functions which are known per se and which are based on the factorization problem or the discrete logarithm problem.

In a further aspect, the invention relates to a method for transmitting a partial chain of a resulting chain of keys. The partial chain has a start key and an end key. Transmitting the partial chain to a receiver merely necessitates transmitting to the receiver the end key of the first chain and the start key of the second partial chain. The receiver thereby acquires the necessary information for calculating all keys of the partial chain of the resulting chain.

According to one embodiment of the invention, an extension of the partial chain is transmitted to the receiver by virtue of the fact that only one further key of the first chain is transmitted to the receiver, wherein the further key in the first chain lies, in the forward direction of the first chain, behind the key transmitted first. This enables the receiver to calculate further keys of the resulting chain which follow the initially received partial chain.

According to one embodiment of the invention, the transmission of the key of the first chain and the key of the second chain to the receiver is effected via a network, in particular a public network, such as, for example, the Internet, satellite or broadband cable distribution networks. In order to protect the transmitted keys against covert interception, the transmission is effected in an encrypted manner, preferably according to a secure messaging method.

The first and second chains and the resulting chain can be assigned to a specific subscriber or a specific subscriber group, that is to say that separate keys are generated for each subscriber or each subscriber group. Furthermore, the length of the resulting chain can be limited. If the resulting chain has reached a maximum length, a new resulting chain is generated beginning with new start values for the first and/or second chains. This is advantageous particularly if one or more subscribers have e.g. cancelled and then resumed their subscription.

In a further aspect, the invention relates to a method for receiving a partial chain of a resulting chain of keys with the aid of the security module. From the received key of the first chain, the security module calculates predecessor keys in the first chain by applying the first function. Furthermore, the receiver calculates successor keys from the received key of the second chain using the second function. From the keys of the first and second chains calculated as a result, the receiver then calculates keys of the partial chain of the resulting chain. A further key already present at the receiver can optionally be used for this purpose. Said further key serves for generating a resulting key from keys of the first and second partial chains.

“Reception” of the resulting chain or partial chain is therefore understood here to mean that only two keys are actually received, from which further keys are then calculated, from which the keys of the resulting chain or partial chain then arise.

According to one embodiment of the invention, an extension of the partial chain is received by the reception of a further key of the first chain, which lies in the first chain behind the initially received key.

For the case where a subscription is not intended to be extended, rather the case involves resumption of the subscription after a temporal interruption, the following procedure can be adopted in accordance with embodiments of the invention:
Alongside the further key of the first chain, the index of the first chain is concomitantly transmitted to the security module, said index corresponding to the time of the resumption of the subscription.
Resumption takes place as in the case of a new subscription, that is to say that a first key of the first chain and a second key of the second chain are transmitted to the security module, which correspond to the time period of the resumed subscription. The program instructions of the security module are then embodied such that the keys of the resulting chain which relate to the time period during the interruption of the subscription are not calculated or at least not output.
After a subscription has expired or even after calculation of the resulting keys, the keys of the first and second partial chains are erased. Therefore, only the resulting keys are stored. For an extension of a subscription or the resumption of a subscription, an analogous procedure can then be adopted, that is to say that in each case a first key of the first chain and a second key of the second chain corresponding to the time period of the extension or the resumption are transmitted to the security module in order to calculate the corresponding keys of the resulting chain therefrom and to store them in the nonvolatile protected memory. This has the advantage, firstly, that no distinction has to be made logically between an extension and a resumption after temporal interruption on the part of the security module and that, secondly, the keys of the resulting chain, which, after all, are generally associated with costs for the subscription, nevertheless remain stored in the security module, even after the keys of the first and second partial chains have been erased after the calculation of the keys of the resulting chain.

In a further aspect, the invention relates to a computer program product comprising executable instructions for executing one or more of the methods according to the invention.

In a further aspect, the invention relates to a computer system for determining a resulting chain of keys, wherein the computer system has means for generating the first chain and the second chain of keys. The calculation of the resulting chain from the keys of the first and second chains can be effected by this computer system itself or by another computer system, such as, for example, a provider computer system of a provider of an online service or product.

In a further aspect, the invention relates to a computer system for receiving the first chain and the second chain and optionally the resulting chain of keys. The provider computer system encrypts for example files or programs with the aid of the keys of the resulting chain and transmits to its subscribers in each case a partial chain of the resulting chain, wherein the partial chain transmitted to a subscriber corresponds to the provider's service utilized by said subscriber.

In a further aspect, the invention relates to an electronic device for receiving a partial chain of the resulting chain of keys. The computer system can be a personal computer of a subscriber. In order to avoid misuse of the partial chain received by the subscriber, the computer system can be a so-called trusted computing platform. The electronic device can also be a smart card, a USB stick, an RFID tag or some other security token, or the electronic device comprises such a security token or an interface to a security token.

According to embodiments of the invention, the electronic system comprises a security module according to the invention, in particular a smart card, and a conditional access module (CAM). The security module, that is to say the smart card, is inserted into a slot of the CAM. The smart card receives the first and second keys via the CAM and outputs the keys of the resulting chain to the CAM, such that the CAM can thus decrypt files or, for example, an audio and/or video transmission, such as e.g. of a unicast, multicast or broadcast audio and/or video signal, in particular of a television signal.

Embodiments of the invention are explained in greater detail below with reference to the drawings, in which:

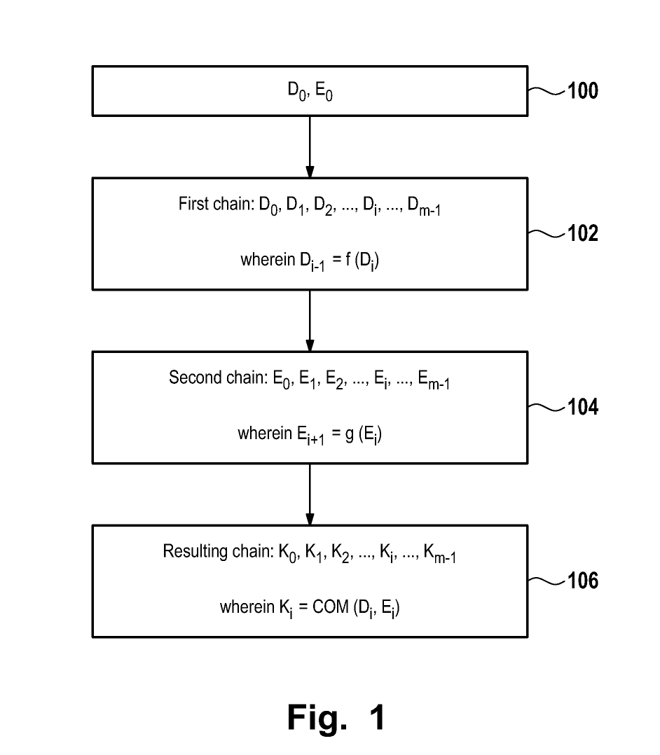

FIG. 1 shows a flowchart of an embodiment of a method according to the invention for determining a resulting chain of keys,

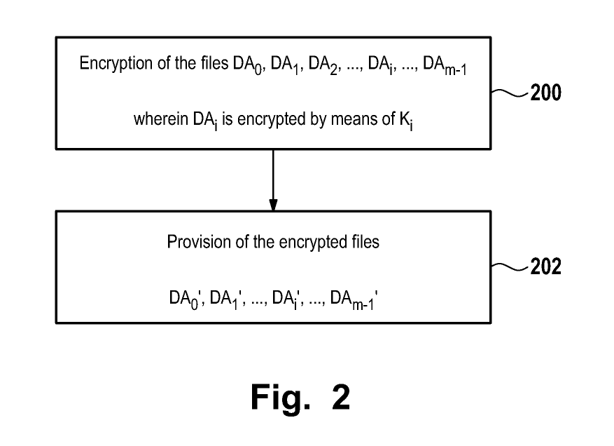

FIG. 2 shows a flowchart of an embodiment of a method according to the invention for providing encrypted files,

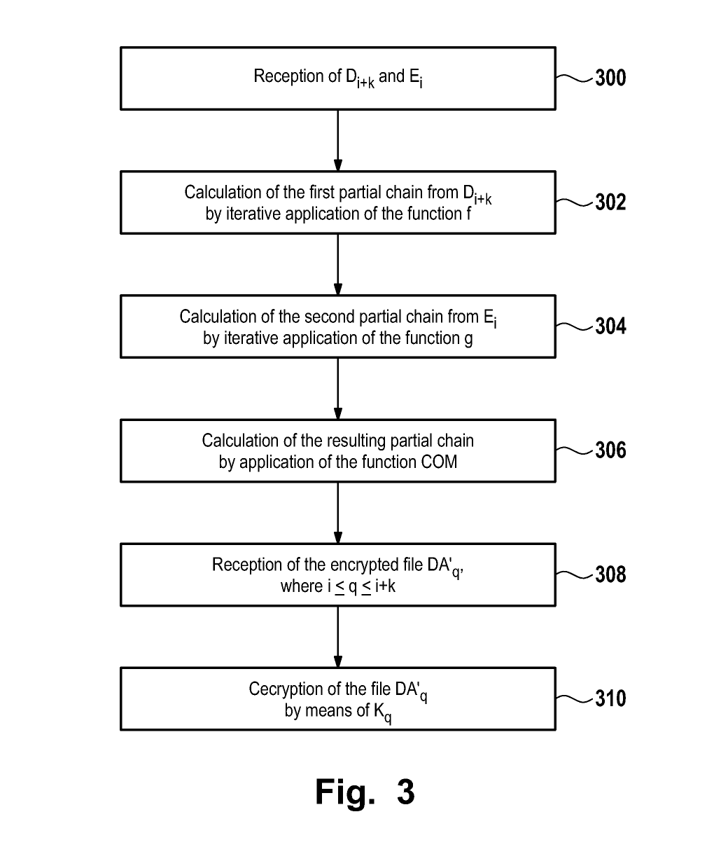

FIG. 3 shows an embodiment of a method according to the invention for receiving a partial chain of the resulting chain,

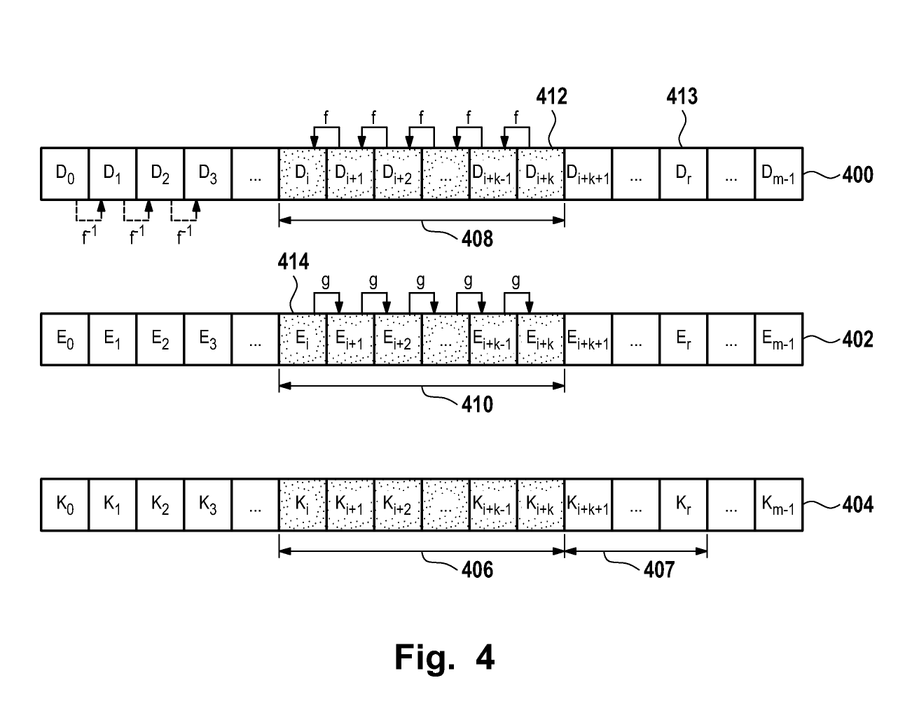

FIG. 4 shows a diagram for representing an embodiment of a method according to the invention for determining a resulting chain and for extending the resulting chain,

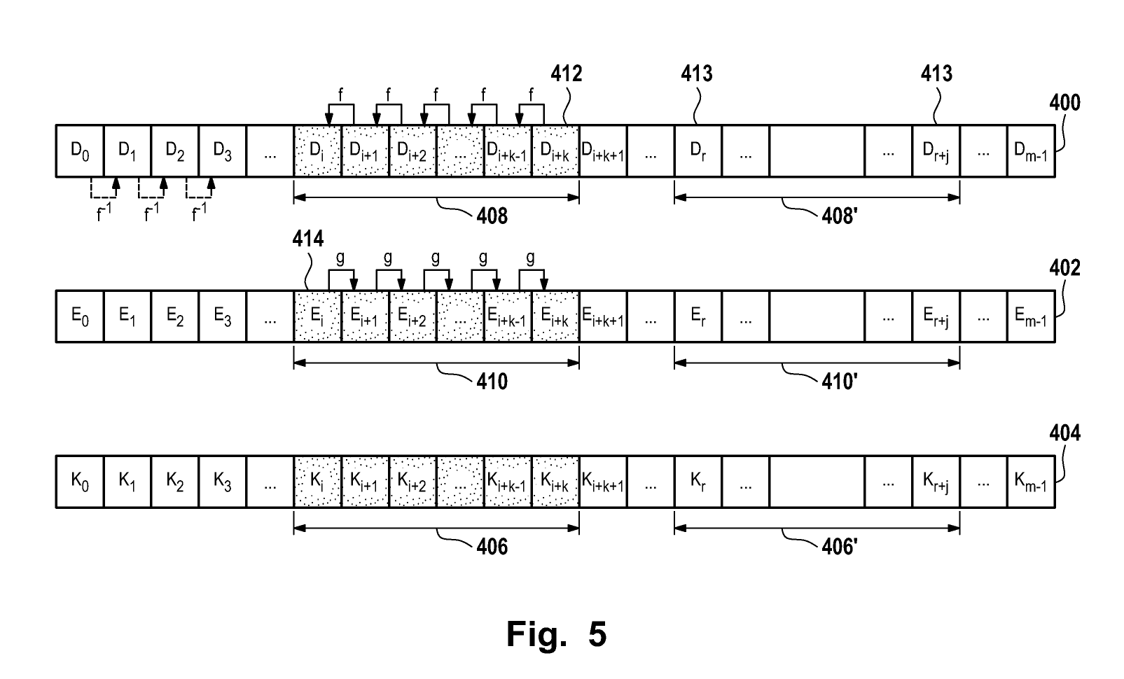

FIG. 5 shows a diagram for representing an embodiment of a method according to the invention for resuming a subscription after an interruption,

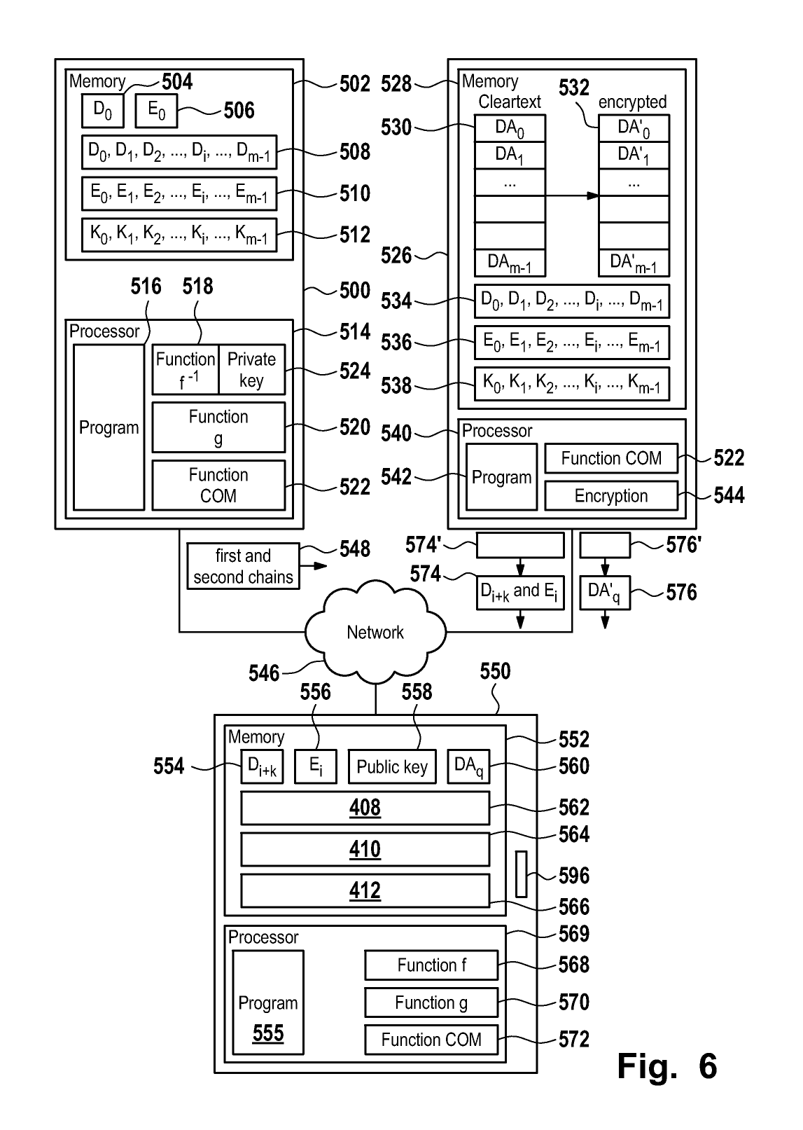

FIG. 6 shows a block diagram of an embodiment of computer systems according to the invention and of an electronic device according to the invention,

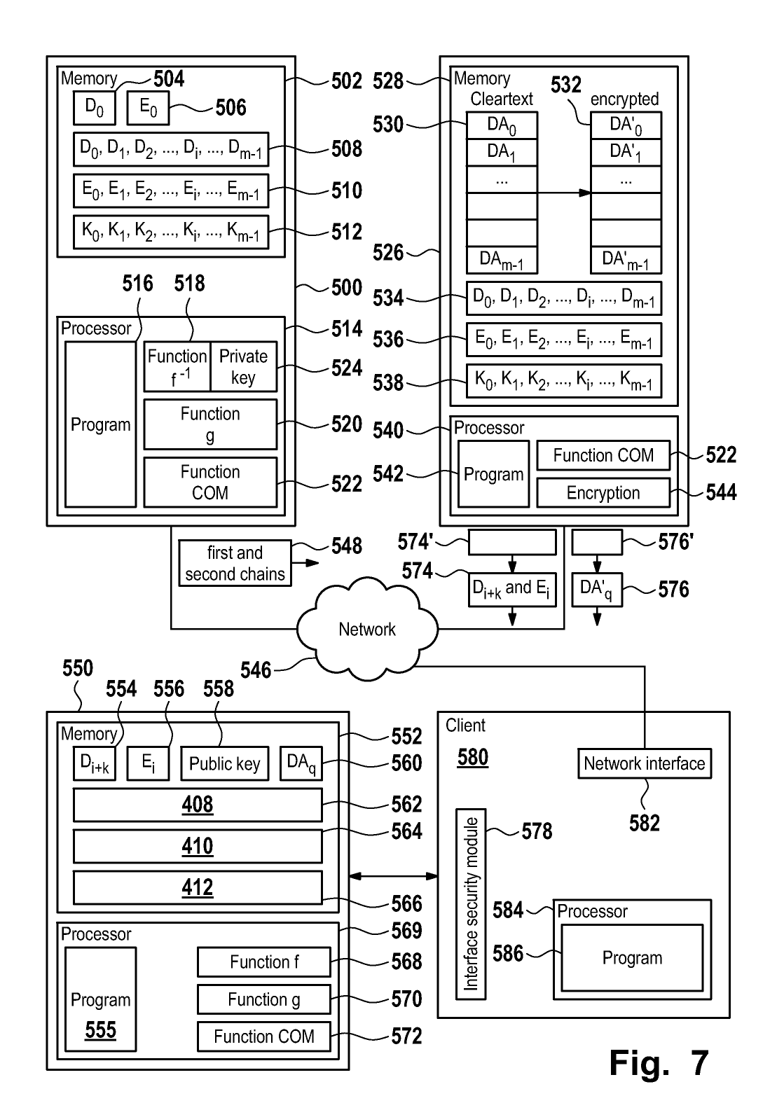

FIG. 7 shows a block diagram of a further embodiment of computer systems according to the invention and of an electronic device according to the invention,

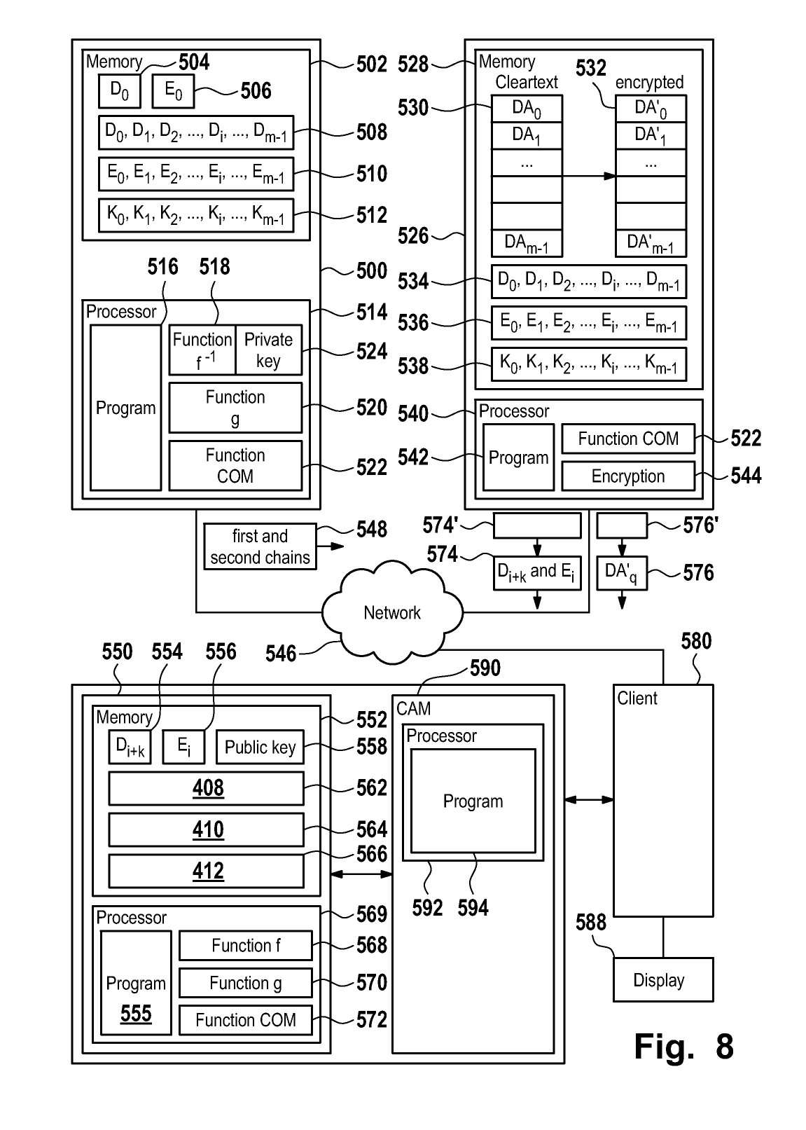

FIG. 8 shows a block diagram of an embodiment of computer systems according to the invention and of an electronic device according to the invention with a CAM.

Elements of the following embodiments which correspond to one another are in each case identified by the same reference symbols.

FIG. 1 shows an embodiment of a method according to the invention for determining a resulting chain of keys K₀, K₁, . . . , Kᵢ, . . . , Kₘ₋₁, wherein the resulting chain is intended to have a number of m cryptographic keys.

In order to determine this resulting chain, start parameters D₀ and E₀ are input in step 100. The start parameter D₀ is the first key of a first chain, which is generated in step 102. This is done by choosing a successor key Dᵢ for each predecessor key Dᵢ₋₁ of the first chain such that the predecessor key results again when a function f is applied to the successor key.

In particular, the function f can be a one-way trapdoor function or a one-way hash function, if the executing unit has so much computing capacity that it can find an x for a given y, such that y=f(x). In any event, a successor key can be calculated for each predecessor key of the first chain with the aid of the inversion of the function f, for which purpose “trapdoor” has to be known or sufficient computing capacity has to be available.

For example by iteratively applying the inversion of the function f, therefore, in step 102, the further keys Dᵢ of the first chain are calculated step-by-step from the start parameter D₀, that is to say the start key of the first chain, wherein the first chain in the embodiment under consideration here has the same length m as the desired resulting chain.

Step 104 involves calculating a second chain of keys beginning with the start parameter E₀, to be precise with the aid of a function g, which is a one-way function or one-way trapdoor function. By iteratively applying the function g, therefore, the keys of the second chain are successively calculated beginning with the start parameter E₀, that is to say beginning with the start key of the second chain.

In step 106, in each case at least one key of the first chain and one key of the second chain are selected in order to determine a key of the resulting chain from the selected keys. In this case, the selection of the keys from the first and second chains is effected according to a predefined scheme. By way of example, in order to determine a key Kᵢ of the resulting chain, the keys Dᵢ of the first chain and Kᵢ of the second chain are selected and subsequently combined with one another by a combination function COM, optionally using a further key.

By way of example the combination function COM is embodied such that each key of the resulting chain is determined by a key of the first chain and a key of the second chain being combined with one another in a predefined manner. This can be effected, for example, such that the two keys are attached to one another, that is to say concatenated, by the two keys being subjected to a logical and/or arithmetic operation, for example a bit-by-bit exclusive-OR (XOR) operation, or by a function value of a one-way function, for example a cryptographic HASH value, being determined from the two keys. In this case, the selection of at least one key from the first chain and at least one key from the second chain for the determination of a key of the resulting chain can be effected in the order given by the chains or according to another predefined scheme; optionally the selection can also be made on the basis of a further key, by means of which the selection is defined or using which the resulting key is calculated.

According to embodiments of the invention, a secret key is stored in the nonvolatile protected memory 566 (cf. FIGS. 6 to 8). The program 555 is then embodied such that, according to the predefined scheme, at least one of the first keys and one of the second keys of the first and second chains, respectively, are selected, which are optionally combined or concatenated with one another. The secret key is read out from the nonvolatile protected memory by the program 555, and the first and second keys that were possibly combined or concatenated with one another are input as an input into an algorithm and the secret key is input as a secret into the algorithm. On account of carrying out the algorithm, the program 555 then acquires a key of the resulting chain. By way of example, it is possible to use an algorithm in accordance with ISO 9797-1, ISO 9797-2, ISO 9797-3, wherein the so-called MAC is used for the resulting key, that is to say that the MAC calculated by the algorithm is the resulting key.

A MAC algorithm otherwise denotes in the prior art an algorithm which calculates a MAC (message authentication code) for a message using a secret key, with which MAC the receiver can check whether the message actually originates from the entity assumed by the receiver because the latter has previously exchanged the secret key with said entity. According to embodiments of the invention, such a MAC algorithm is used for a completely different purpose, namely for calculating a resulting key from two input values (first and second keys) and a secret key used for carrying out the MAC algorithm.

The first chain is therefore calculated on the basis of an invertible one-way trapdoor function f: y=ƒ(x). For an x-value there is only one y-value. The inversion of the function ƒ(x), that is to say the inverse function thereof, is designated by x=ƒ⁻¹(y). x need not be single-valued, but the following holds true

y=ƒ(ƒ⁻¹(y))

the identity in this and following formulae can also mean equivalence if residue class arithmetic (modulo arithmetic) is used, that is to say that ƒ(ƒ⁻¹(y)) and y lie in the same residue class.

One example of a one-way trapdoor function ƒ(•) is the RSA function

y=ƒ(x)=x^{e} mod n

ƒ(•) is a one-way trapdoor function, because y is easy to calculate. x<n, n=pq is a product of two prime numbers p and q. The exponent e≠0 is assumed to be known, where gcd(e,φ(n))=1. e is generally a system parameter.

A value of the inverse function

x=ƒ⁻¹(y)=y^{d} mod n

can only be calculated if d is known, if y≧2. The expression x=y^{d} mod n produces a number x<n, for which x^{e} mod n=y holds true.

The calculation of d<n takes place by means of the equation ed mod φ(n)=1, or ed mod(p−1)(q−1)=1, which can be solved only with knowledge of p and q.

d denotes the secret required to calculate the inversion of ƒ(•). ƒ(•) is therefore a one-way trapdoor function. The exponent d is also designated as a private key.

The requirements made of the parameters and the function ƒ⁻¹(•) according to the RSA method are described in the literature, cf. A. Beutelspacher, “Moderne Verfahren der Kryptographie” [“Modern Methods of Cryptography”], Vieweg Verlag, 2004.

There are also numerous other trapdoor functions, e.g. the Rabin method or methods based on the discrete logarithm problem. In the following embodiments, however, without restricting the generality, the abovementioned RSA method is used, since the function ƒ(•) can be executed particularly easily and is therefore suitable for the electronic components of the subscribers, which possibly do not have a great computing capacity.

The determination of the resulting chain in accordance with the embodiment in FIG. 1 is therefore effected by start parameters D₀ and E₀ being generated at the generator end (cf. step 100).

Dᵢ₋₁ has to satisfy the prerequisite that Dᵢ can be calculated from Dᵢ₋₁, that is to say that the following holds true

Dᵢ=ƒ⁻¹(Dᵢ₋₁) i=1, 2, . . .

The calculations are only possible with knowledge of the secret or with very great complexity which is not possible for the subscribers. For this purpose, depending on the chosen function ƒ, it may be necessary to choose a suitable random start value for D₀. If there are a plurality of Dᵢ which fulfill the abovementioned equation for Dᵢ₋₁, it is necessary to choose from them a value for which said equation is likewise fulfilled, that is to say for which the following holds true:

Dᵢ₊₁=ƒ⁻¹(Dᵢ) i=1, 2, . . .

Furthermore, the abovementioned prerequisite is necessary for the purpose of iterative application.

The calculation of Dᵢ need not be single-valued, since ƒ⁻¹(•) need not be single-valued.

The following holds true for the one-way function g(•)

Eᵢ₊₁=g(Eᵢ) i=1, 2, . . .

By way of example, the RSA method is used: the generator calculates two random natural numbers G₀≠0 and F₀≠0 which are less than n, but have approximately the same order of magnitude as n (length a few bits smaller) and determines

D₀=F₀^{e} mod n

E₀=G₀^{e} mod n

where

n=pq.

In general, it is necessary that gcd(e,φ(n))=1, the further requirements made of p, q and e can be gathered from the literature, and n and e are made known to all the subscribers as system parameters.

The divisor n can be different in the calculation of D₀ and E₀.

If other methods are used, it may be necessary to fulfill other conditions for the choice of the start values D₀ and/or E₀.

The generator calculates with the aid of the formula

Dᵢ=(ƒ⁻¹)ⁱ(D₀)=ƒ⁻¹(ƒ⁻¹( . . . ƒ⁻¹(D₀))) (application of the function ƒi-times)

the keys Dᵢ for i=1, 2, . . . , i.e. the first chain (cf. step 102). The D, are designated hereinafter as backward keys.

Moreover, the generator calculates with the aid of the formula

Eᵢ=gⁱ(E₀)=g(g( . . . g(E₀))) (application of the function g i-times)

the keys Eᵢ for i=1, 2, . . . , i.e. the second chain (cf. step 104). The Eᵢ are designated as forward keys.

Upon application of the RSA method this means:

Dᵢ=D₀^{d}^{ⁱ} mod n, i=1, 2, . . .

Moreover, the generator calculates with the aid of the formula

Eᵢ=E₀ mod n, i=1, 2, . . .

the keys Eᵢ for i=1, 2, . . .

From the keys Dᵢ and Eᵢ, the service provider calculates the key Kᵢ used for the encryption for example as follows:

Kᵢ=COM(Dᵢ,Eᵢ)

In this case, COM(•) is a function which combines Dᵢ and Eᵢ with one another and creates a value which meets the requirements made of a secure key of the method to be used for encryption.

By way of example, the length of n is 2048 bits. Dᵢ and Eᵢ, Dᵢ, Eᵢ<n, likewise have the length of n bits, for example. However, it can also happen that some leading bits of Dᵢ and/or Eᵢ can be zero. However, a key having the length of 128 bits is required for the encryption. A one-way HASH function is then applied to Dᵢ and Eᵢ

H(Dᵢ,Eᵢ)

and the result is trimmed according to the required length; e.g. the 128 bits situated on the right are taken. Examples of a one-way HASH function are known from J. Buchmann, “Einfuhrung in die Kryptographie” [“Introduction to Cryptography”], Springer Verlag, 2004, or from ISO 9797-2 and ISO 9797-3. If further security requirements or requirements in respect of the format or the construction of the key are made in respect, then these should also be taken into account by the function COM(•). The function COM(•) can therefore be composed of a plurality of functions and in this case can also include a secret or private key.

The resulting chain of cryptographic keys which is obtained in this way can be used for various purposes. The present invention is particularly suitable for regulating access to a temporal order of services or products issued in a temporal order. In this case, the present invention is equally suited to services provided online or products supplied online and also to so-called “real world” services and products.

In one embodiment of the invention, a resulting chain of cryptographic keys is generated in order to regulate the access rights of subscribers to a service or a product, such as a magazine, for example. By way of example, the magazine appears weekly by virtue of a file DA_{Week} being provided for download on an Internet platform of the publisher of the magazine. Previous issues of the magazine are also available for download on said Internet platform. The files DA_{Week} are in each case encrypted with the aid of a cryptographic key of the resulting chain in order that only authorized subscribers can acquire access to the magazines.

By way of example, for each publication year of the magazine, a resulting chain of k=52 cryptographic keys K₀ to K₅₁ is generated in advance. As soon as the magazine is intended to be newly published, its corresponding file DA_{Week} is encrypted with one of the keys of the resulting chain. By way of example, the magazine of Week i, that is to say its corresponding file DA_{i=Week}, is encrypted with the cryptographic key of the resulting chain with the same index i, that is to say with Kᵢ, (cf. step 200 in the method in FIG. 2). The magazine for the Week i is then made available for download to the subscribers on the Internet platform by the encrypted file DAᵢ′ being provided for download.

For a subsequent publication year of the magazine, an extension of the resulting chain by a further k=52 cryptographic keys is calculated. This can be done such that the iterative implementation of the calculation of the first chain and of the second chain in steps 102 and 104 in FIG. 1 is resumed again beginning with the last element of the respective chain, that is to say beginning with Dₘ₋₁ and Eₘ₋₁, respectively, in order to calculate further keys Dₘ to D₂ₘ₋₁ and Eₘ to E₂ₘ₋₁. The extension of the resulting chain, that is to say the keys Kₘ to K₂ₘ₋₁, is then calculated from these extensions of the first and second chains. With these further keys Kₘ to K₂ₘ₋₁, the files of the magazines published in the subsequent year are then encrypted and successively provided for download, as was the case when executing steps 200 and 202 for the first-mentioned publication year.

The encryption of the files in step 200 can be effected by symmetrical and/or asymmetrical encryption methods with the aid of the keys of the resulting chain. In principle, it is possible to use any encryption method which meets the security requirements. In this case, the cryptographic keys of the resulting chain can be used directly for encryption or for the derivation of encryption of further cryptographic keys, which are then used for the actual encryption. The length of the keys is predefined by the cryptographic encryption method used; it can be 56, 64, 128, 192 or 256 bits for example.

It should be pointed out that each file DAᵢ need not necessarily be encrypted with a different key Kᵢ; it is also possible for a plurality of files to be encrypted with the same key Kᵢ.

Embodiments of the present invention are particularly advantageous since, for key management, it is not necessary for the individual cryptographic keys of the resulting chain to be distributed to the subscribers. With regard to a subscriber wishing for example to procure the magazine for a certain time period, for example for weeks i to k it is merely necessary to receive the key Dᵢ₊ₖ of the first chain and the key Eᵢ of the second chain (cf. steps 102 and 104 in FIG. 1) in step 300 in accordance with the method in FIG. 3.

In step 302, from the received key Dᵢ₊ₖ, it is possible to calculate the predecessor key in the first chain, that is to say the key Dᵢ₊ₖ₋₁, by applying the function f. By iteratively applying the function f to the predecessor key respectively calculated, it is thus possible to calculate the keys for example up to the key Dᵢ.

In step 304, the successor key Eᵢ₊₁ is calculated from the key Eᵢ by applying the function g. By iteratively applying the function g in each case to the successor key, the keys of the second chain which follow the key Eᵢ can therefore be calculated. By way of example, the calculation is effected up to the key Eᵢ₊ₖ.

In step 306, from the keys calculated in steps 302 and 304, a partial chain of the resulting chain is calculated by applying the function COM. In the case of the example under consideration here, therefore, the keys Kᵢ to Kᵢ₊ₖ are calculated. This can be done in advance or as required, that is to say for example upon the reception of an encrypted file DA_{q}′ in step 308, where i≦q≦i+k. In step 310, the encrypted file DA_{q}′ can be decrypted by means of the associated key K_{q} of the resulting chain.

In a further exemplary case, a service that is provided daily is involved. Therefore, a key change takes place daily. The service provider offers access to a service in the form of a monthly subscription. If a subscriber purchases such a monthly subscription, then said subscriber acquires a key Eᵢ and a key Dᵢ₊₃₀ for a month having 30 days. From these two keys, the keys Dᵢ to Dᵢ₊ₖ₋₁ of the first chain and the keys Eᵢ₊₁ to Eᵢ₊₃₀ of the second chain can be calculated at the subscriber end. From these keys, in turn, the resulting keys Kᵢ to Kᵢ₊₃₀ can be calculated by means of the function COM, such that the subscriber obtains possession of the 30 resulting keys for said subscriber's monthly subscription on account only of the reception of the keys Eᵢ and Dᵢ₊₃₀.

By way of example, the subscription is extended at the end of the month unless it is cancelled. The subscriber then acquires for each subsequent month a further key from the first chain, for example the key Dᵢ₊₃₀₊₃₁ for the next following month, in order to determine therefrom an extension of the partial chain of the first chain already calculated previously, namely the keys Dᵢ₊₃₁ to Dᵢ₊₆₁. For the extension of the partial chain of the second chain already calculated previously, the subscriber does not need additional information since said subscriber can extend the latter as desired by iteratively applying the function g in the forward direction. From the extension of the first and second partial chains, the further keys Kᵢ₊₃₁ to Kᵢ₊₆₁ for the subsequent month can then be calculated at the subscriber end.

Over a year, therefore, only 13 keys then have to be transmitted to the subscriber. Without the method according to the invention, by contrast, a new key would have to have been transmitted for each day, that is to say a total of 365 keys. The invention therefore enables the complexity required for key management to be drastically reduced.

A further example is the distribution of a plurality of programs by a service provider. Said programs are encrypted independently of one another. The cryptographic key of the resulting chain for the program encryption is changed daily, that is to say that each of the subscribers requires a new key for each day. If a subscriber subscribes to a plurality of programs, said subscriber correspondingly requires a plurality of keys daily in order to be able to utilize the programs to which said subscriber has subscribed. However, such programs can also be combined into packages, wherein each package is encrypted with a single key. Furthermore, subscribers can also be combined into subscriber groups which each share common keys with one another, that is to say use the same key.

Embodiments of the method according to the invention enable every subscriber to calculate the resulting keys themselves from the beginning for a duration of their subscription that is predefined by the service provider of the programs, for example until the end of the term of the contract. If the term of the contract is expressly or tacitly extended, a subscriber acquires a further key of the first chain which enables the subscriber to calculate themselves the further resulting keys required during the extended term of the contract.

Said calculation can be carried out for example as follows:

The subscriber is intended to be enabled to calculate the resulting keys Kᵢ, . . . , Kᵢ₊ₖ for the decryption of the subscription service, in order that said subscriber can utilize the service. The keys Kᵢ, Kᵢ₊₁, . . . , Kᵢ₊ₖ are used successively for encryption. Said subscriber ought not to be able to decrypt the data of the subscription service which are encrypted with the keys K₀, . . . , Kᵢ₋₁ and with the keys Kᵢ₊ₖ₊₁, . . . . For this purpose, said subscriber acquires the keys Eᵢ and Dᵢ₊ₖ from the service provider.

Upon acquiring Eᵢ, the subscriber is able, with the aid of the following formula, to calculate all subsequent Eᵢ₊₁, Eᵢ₊₂, . . . .

Eᵢ₊ⱼ=g^{j}(Eᵢ)=g(g( . . . g(Eᵢ))) (application of the function g j-times), j=1, 2, . . .

However, said subscriber is not able to calculate E₀, . . . , Eᵢ₋₁, since g(•) is e.g. a one-way trapdoor function or a Hash function, wherein the subscriber does not know the secret or does not have sufficient computing capacity to calculate the inverse function of g(•).

Upon acquiring Dᵢ₊ₖ, the subscriber is able, by applying the formula

Dᵢ₊ₖ₋ⱼ=ƒ^{j}(Dᵢ₊ₖ)=ƒ(ƒ( . . . ƒ(Dᵢ₊ₖ))) (application of the function ƒj-times), j=1, 2, . . . , i+k

to calculate D₀, . . . , Dᵢ₊ₖ₋₁ but not Dᵢ₊ₖ₊₁, D_{i+k+2, . . . . Therefore, the D}ᵢ are called backward keys because all predecessor keys can thereby be derived.

When the RSA method is applied, upon acquiring Eᵢ, the subscriber is able, with the aid of the following formula, easily to calculate all subsequent Eᵢ₊₁, Eᵢ₊₂, . . . .

Eᵢ₊ⱼ=Eᵢ^{e}^{^{j}} mod n, j=1, 2, . . .

However, said subscriber is not able to calculate E₀, . . . , Eᵢ₋₁, since said subscriber does not know the private key d. For calculating d, said subscriber requires p and q, which are likewise not known to said subscriber.

Upon acquiring Dᵢ₊ₖ the subscriber is able, by applying the formula

Dᵢ₊ₖ₋ⱼ=Dᵢ₊ₖ^{e}^{^{j}} mod n, j=1, 2, . . . i+k to calculate D₀, . . . , Dᵢ₊ₖ₋₁, but not D_{i+k+1,}Dᵢ₊ₖ₊₂, . . .

In order to calculate the keys Kᵢ₊ⱼ for j=0, . . . , k, a subscriber requires the valid forward and backward keys:

Kᵢ₊ⱼ=COM(Dᵢ₊ⱼ,Eᵢ₊ⱼ)

The abovementioned examples relate predominantly to a temporally dependent key change. However, the key change can also take place in an event-oriented manner; by way of example, a subscription can comprise a specific number of episodes. The independent calculation of the resulting keys by the subscriber is then dependent on the number of key changes to which the subscriber is authorized, and not on the time, i.e. for example on the number of subscription episodes.

FIG. 4 shows by way of example a first chain 400, which comprises a number of m first keys D₀ to Dₘ₋₁. The first chain 400 has been generated in a manner corresponding to step 102 in the embodiment in FIG. 1. Furthermore, FIG. 4 shows, by way of example, a second chain 402 having a number of m second keys E₀ to Eₘ₋₁. The second chain 402 has been generated in a manner corresponding to step 104 in the embodiment in FIG. 1.

Furthermore, FIG. 4 shows by way of example a resulting chain 404 of a number of m resulting keys K₀ to Kₘ₋₁. This resulting chain 404 can be defined in a manner corresponding to step 106 in the embodiment in FIG. 1.

By way of example, a partial chain 406 of resulting keys Kᵢ to Kᵢ₊ₖ is intended to be transmitted to a subscriber. The partial chain 406 includes the partial chain 408 of the first chain 400, which has the first keys D₀ to Dᵢ₊ₖ, and also the partial chain 410 of the second chain 402, which has the second keys Eᵢ to Eᵢ₊ₖ, since these keys of the partial chains 408 and 410 serve for defining the corresponding keys of the partial chain 406.

For transmitting the partial chain 406 to a subscriber, initially it is merely necessary to transmit the end key 412 of the partial chain 408, that is to say the key Dᵢ₊ₖ, and also the start key 414 of the partial chain 410, that is to say the key Eᵢ, to the subscriber (cf. step 300 in FIG. 3).

By repeatedly applying the function f, it is then possible to calculate the predecessor keys of the end key 412 of the partial chain 408 at the subscriber end, as illustrated in FIG. 4 (cf. step 302 in the embodiment in FIG. 3). From the start key 414, by contrast, it is possible to calculate the successor keys of the start key 414 in the partial chain 410 by iteratively applying the function g (cf. step 304 in the embodiment in FIG. 3). From the partial chains 408 and 410, it is then possible to calculate the partial chain 406 at the subscriber end, for example by applying the function COM (cf. step 306 in the embodiment in FIG. 3).

If the partial chain 406 is subsequently intended to be extended by an extension 407 to the key Kᵣ, then it is merely necessary to transmit a further key 413, i.e. Dᵣ, of the first chain 400 to the subscriber, where i+k<r≦m−1. This is because an extension of the partial chain 408 can be calculated from this updated end key 413 at the subscriber end.

For calculating an extension of the partial chain 410, the subscriber does not require such additional information, since said subscriber here, for calculating successor keys which follow the previous end key of the partial chain 410, merely has to iteratively apply the function g. Therefore, the transmission of an arbitrary extension 407 of the partial chain 406 merely necessitates the transmission of a single further key 413 of the first chain 400, which lies in the forward direction behind the previous end key 412.

The predefined scheme can now be applied again in order to determine the extension 407 of the resulting chain 404 from the extensions of the partial chains.

FIG. 5 shows an embodiment of the invention in which a subscription is resumed after a temporal interruption.

In the case of a subscription for the first time, the procedure as explained above with reference to FIGS. 3 and 4 is thus adopted, that is to say that the keys Dᵢ₊ₖ and Eᵢ are transmitted to the security module, which thereupon calculates the keys Kᵢ to Kᵢ₊ₖ and stores them in a nonvolatile protected memory, such that the resulting keys can be used for decrypting successive issues of subscription content or e.g. a sequence of digital audio and/or video signals, for example television signals. After the calculation of the keys Kᵢ to Kᵢ₊ₖ of the resulting chain, that is to say of the partial chain 406, all of the keys of the partial chains 408 and 410 are erased.

For resuming the subscription at a later point in time, in order for example to procure episodes r to r+j of the subscription content, the procedure adopted is likewise analogous to FIGS. 3 to 4, that is to say that the key Dᵣ₊ⱼ of the first chain 400 and the key Eᵣ of the second chain 402 are received by the security module. The security module then calculates therefrom, in a manner corresponding to the embodiment in accordance with FIG. 3, the keys Kᵣ to Kᵣ₊ⱼ of the partial chain 406′ of resulting keys, which are in turn likewise stored in the nonvolatile protected memory of the security module, whereas the keys of the partial chains 408′ and 410′ are erased after this calculation. This procedure has the advantage that the user of the security module, on account of the new subscription of said user, does not acquire access to the keys Kᵢ₊ₖ₊₁ to Kᵣ₋₁ for which he or she has, after all, not actually paid.

On the other hand, the possibility of access to already paid content, on the basis of the original subscription or subsequent resumptions after temporal interruption, is not lost, since the determined resulting keys of the partial chains 406 and 406′, for example, are, after all, stored in persistent fashion in the security module.

Preferably, the program 555 of the electronic device 550 (cf. FIGS. 6, 7 and 8) is embodied such that the calculation of the resulting keys of the partial chains 406 and 406′, for example, is effected in accordance with the embodiment according to FIG. 5. This means that after the calculation of the partial chain 406 and the storage thereof in the memory area 566, the memory areas 554, 556, 562 and 564 are erased. If the electronic device receives a message 574′ with the keys Dᵣ₊ⱼ and Eᵣ (cf. FIG. 5) at a later point in time, then the program 555 calculates therefrom the partial chain 406′ and stores the latter behind the partial chain 406 in the memory area 566 of the electronic device 550. This procedure is likewise adopted if further messages 574″ etc. with corresponding key pairs for further new subscriptions are received by the electronic device 550.

According to embodiments of the invention, the memory areas 554, 556, 562 and 564 are embodied as a self-erasing memory, that is to say as a memory whose content is automatically erased on account of a read access. In particular, the memory areas 554, 556, 562 and 564 can be FRAM.

The memory area 566 is a nonvolatile protected memory area of the electronic device 550, to which external access is not possible. In the embodiment under consideration here, the decryption of the encrypted file 576 and of subsequent encrypted files 576′, . . . , which belong to the subscription is effected by the electronic device 550, for example by the program 555 thereof.

FIG. 6 shows a computer system 500 embodied as a key generating unit for defining the first and second chains, optionally also a resulting chain (cf. resulting chain 404 in FIG. 4). For this purpose, the computer system 500 has a memory 502 having a memory area 504 and a memory area 506 for storing the start parameters D₀ and E₀, that is to say the start keys of the first chain 400 and of the second chain 402, respectively, in the embodiment in FIG. 4.

The memory 502 furthermore has a memory area 508 for storing the first chain 400 and a memory area 510 for storing the second chain 402. optionally, the memory 502 furthermore has a memory area 512 for storing the resulting chain 404.

The computer system 500 has at least one processor 514 for executing a program 516, which can access the program modules 518 and 520 and also optionally 522. The program module 518 implements the inverse function of the function f, that is to say the function f¹, and the program module 520 implements the function g. Furthermore, the optional program module 522 implements the function COM.

The computer system 500 furthermore has access to a private key 524, which is the “trapdoor” for the calculation of the function f⁻¹. The computer system 500 can be a so-called Trusted Computing Platform, in particular in order to prevent unauthorized access to the private key 524. The storage of the private key 524 and also the program module 518 can also be implemented in a smart card or in some other security token.

In order to define the chains 400, 402 and optionally 404, the computer system 500 executes the method in accordance with FIG. 1, for example, by virtue of the program 516 accessing the memory areas 504 and 506 in order to read out D₀ and E₀, such that, with the aid of the program modules 518 and 520, the first and second chains 400 and 402 are thereupon calculated and stored in the memory areas 508 and 510, respectively. Optionally, the computer system 500 also calculates the resulting chain 404 with the aid of the program module 522 and stores the resulting chain 404 in the memory area 512. The storage of the first and second chains 400, 402 in the memory areas 504, 506 is not absolutely necessary, since these chains can be calculated anew at any time by the computer system 500.

FIG. 6 furthermore shows a computer system 526 of the provider of an online service or of some other apparatus for providing a resource with access control. In the case of the example under consideration here, the online service relates to the provision of files for download. The computer system 526 has a memory 528 for storing a number m of files DA₀ to DAₘ₋₁ in a memory area 530. The memory 528 furthermore has a memory area 532 for storing the encrypted files DA₀′ to DAₘ₋₁′.

Furthermore, the memory 528 has memory areas 534, 536 and 538 for storing the first chain 400, the second chain 402 and also the resulting chain 404. The storage of the chain 404 in the memory area 538 is not absolutely necessary if the computer system 526 can calculate the chain 404 anew at any time.

The computer system 526 furthermore has at least one processor 540 for executing a program 542, which can access the optional program module 522 and the program module 544. In this case, the program module 544 serves for encrypting the files using the keys of the resulting chain, for example according to a symmetrical encryption method.

The computer system 500 and the computer system 526 can communicate with one another for example via a network 546, in particular the Internet. The transmission of the keys via the network is preferably effected in an encrypted fashion.

During operation, the computer system 526 receives from the computer system 500 a message 548 comprising the first chain 400 and the second chain 402. In addition, the message 548 can also comprise the resulting chain 404. In order to generate the message 548, the program 516 accesses the memory areas 508 and 510 in order to read the first and second chains 400, 402, such that the latter can then be transmitted with the aid of the message 548. Optionally, the message 548 also comprises the resulting chain 404. In the latter case, the computer system 500 has the program module 522 for calculating the resulting chain 404.

If the computer system 526 receives the message 548, then the first chain 400 is stored in the memory area 534 and the second chain 402 is stored in the memory area 536. If the resulting chain 404 is not part of the message 548, then this is calculated with the aid of the program module 522 on the part of the computer system 526.

With the aid of the resulting chain, e.g. the files of the memory area 530 are then encrypted, such that they are then present in encrypted form in the memory area 532. The encrypted files are provided for download on an Internet platform, for example. Instead of files, other data can also be involved, in particular also the data of a data stream. In the latter case, in particular, the data can be encrypted “on the fly”.

The encryption of the data can be effected directly with the keys of the resulting chain. Alternatively, the keys of the resulting chain serve as input values for a further method for deriving the keys with which the data are intended to be encrypted.

The computer systems 500 and 526 can also be one unit, that is to say that the provider of the online service itself provides for generating the key material. The embodiment of a separation of the computer systems 500 and 526 as shown in FIG. 6 is advantageous, however, since the computer system 500 can generate the required key material for different service providers.

An electronic device 550 of a subscriber serves for accessing the encrypted files provided online. The electronic device 550 can be, for example, a personal computer, a cellular telephone, a multimedia receiver with common interface or smart card interface and smart card or the like.

The electronic device 550 of the subscriber is embodied as a security module and has a memory 552 having the memory areas 554, 556, 558, 560, 562, 564 and 566. Furthermore, the electronic device 550 has at least one processor 569 for executing a program 555, which can access the program modules 568, 570 and 572. In this case, the program module 568 implements the function f, the program module 570 implements the function g, and the program module 572 implements the function COM.

In order to enable the subscriber to decrypt the data to which said subscriber has subscribed, the computer system 526 transmits a message 574 to the electronic device 550, for example via the network 546. The message 574 comprises the end key 412 and the start key 414 (cf. embodiment in FIG. 4). The end key 412 is stored in the memory area 554 and the start key 414 is stored in the memory area 556. The message 564 can also comprise the public key which corresponds to the private key 524 and which is then stored in the memory area 558. The public key is preferably communicated in a certificate according to the X.509-Standard. The public key can be stored in the memory 528 in order to transmit it later to the electronic device 550 e.g. with the message 574.

The message 574 is preferably encrypted with a key which was previously allocated to the subscriber or agreed with the latter.

The program 556 then calculates, with the aid of the program modules 568 and 570, the partial chain 408 and 410, respectively, and stores the latter in the memory area 562 and 564, respectively (cf. embodiment in FIG. 4). With the aid of the program module 572, the program 556 then calculates from the partial chains 408 and 410 the partial chain 406 comprising the resulting keys. The latter are stored in the memory area 566.

The electronic device 550 can then load encrypted data 576, comprising for example the encrypted file DA_{q}′ from the memory area 532, via the network 546. The encrypted file DA_{q}' is decrypted by the program 556 with the aid of the key K_{g}, for example, and stored in the memory area 560 for further use by the subscriber.

This procedure can correspondingly be adopted for further subscribers (not shown in FIG. 6).

At least the program module 568 can be implemented on a smart card or an RFID tag which can be accessed by the electronic device 550. If the electronic device 550 is a mobile radio device, then the electronic device 550 can comprise an integrated smart card reader for accessing a telecommunication smart card, such as, for example, a so-called SIM card. The program module 568 can then be carried out by the SIM card, for example, on which the public key 558 can also be stored. Preferably, the keys Dᵢ₊ₖ and Eᵢ are also stored on the SIM card and, preferably, the functions f and g are also implemented in the SIM card. Instead of a smart card, in particular a SIM card, or RFID tag, it is also possible to use some other security token, such as e.g. a USB stick.

Instead of only one asymmetrical key pair consisting of the abovementioned private key and the public key, it is also possible to use different key pairs for the generation of the first and second chains.

Furthermore, the smart card or the SIM card can also be used for executing an encryption method for establishing an encrypted channel for transmitting the message 574 from the computer system 526 to the electronic device 550.

In the computer system 500, that is to say the key generating unit, it is not necessary to store all Dᵢ, Kᵢ and Eᵢ, since they can be reconstructed at any time. The private key 524 should be stored in the memory, this being done best in a protected area; the private key belongs to f⁻¹.

The link from the service provider, that is to say the computer system 526, to the device 550 of the subscriber should be encrypted. A subscriber key required for this purpose can be stored in the device 550 of the subscriber. At the subscriber end, Dᵢ, Eᵢ and Kᵢ should also be stored in a secure memory in order that they cannot be forwarded in an unauthorized manner.

FIG. 7 shows an embodiment of the electronic device 550 according to the invention which is embodied such that it can communicate with an interface 578 of a client 580. By way of example, the interface 578 can be embodied as a USB interface, and the electronic device 550 can be embodied as a so-called USB stick. The client 580 has a network interface 582 for receiving messages 574, 574′, . . . and the encrypted files 576, 576′, . . . via the network 546.

The client 580 furthermore has a processor 584 for executing a program 586.

On account of the reception of the message 574, for example, the keys contained therein, that is to say, for example, Dᵢ₊ₖ and Eᵢ or, for an extension of the subscription, Dᵣ₊ⱼ and Eᵣ, are output via the interface 578 to the electronic device 550. The latter thereupon calculates the corresponding partial chains 406 and respectively 406′ of the resulting chain and stores the latter in the memory area 566. On account of the reception of an encrypted file, e.g. the file 576 or 576′, by the client 580, this encrypted file is transferred via the interface 578 to the electronic device 550, which thereupon performs the decryption, and outputs the decrypted file to the interface 578 of the client 580.

FIG. 8 shows an embodiment of the invention in which the network 546 is embodied for example as a network for transmitting e.g. unicast, multicast or broadcast audio and/or video signals, in particular television signals. The network can be e.g. a satellite-based or terrestrial television system, the Internet, or a digital mobile radio network, such as e.g. according to a UMTS or LTE Standard.

The client 580 is embodied here as a receiver, or as part of a receiver, such as e.g. as a decoding unit, for the audio and/or video signals, wherein the messages 574, 574′, . . . and the encrypted files 576, 576′, . . . are transmitted via the network 546. A display 588 is connected to the client 580. The electronic device 550 is preferably embodied here as a smart card and is situated in an insertion slot of a CAM 590. The CAM 590 has a processor 592 for executing a program 594.

After a message 574 has been received by the client 580, the client 580 inputs the message 574 into the CAM 590, from where it is forwarded by the execution of the program 594 to the electronic device 550, which thereupon carries out the calculation of keys of the resulting chain, for example of the partial chain 406. Said partial chain, such as the partial chain 406, for example, is then output to the CAM 590 by the electronic device 550.

If the client then receives an audio and/or video signal with the encrypted data 576, then this television signal is input by the client 580 into the CAM 590, which decrypts the audio and/or video signal with the keys of the resulting chain, such as of the partial chain 406, for example, and outputs the decrypted audio and/or video signal to the client 580, such that the latter can reproduce the audio and/or video signal via a loudspeaker or headphones and/or on the display 588.

What is particularly advantageous in this case is that the decryption of the audio and/or video signal is not carried out by the electronic device 550, but rather by the CAM 590. The processor 569 of the electronic device 550 therefore need not have a capacity required for the real time decryption of the encrypted audio and/or video signal, since this decryption is carried out by the processor 592 of the CAM 590. On the other hand, the partial chain 406 is not output from the CAM 590 to the client 580 in order, for example, to prevent publication of the partial chain 406 on the Internet.

### LIST OF REFERENCE SYMBOLS

400 First chain
402 Second chain
404 Resulting chain
406 Partial chain
407 Extension
408 Partial chain
410 Partial chain
412 End key
413 Updated end key
414 Start key
500 Computer system
502 Memory
504 Memory area
506 Memory area
508 Memory area
510 Memory area
512 Memory area
514 Processor
516 Program
518 Program module
520 Program module
522 Program module
524 Private key
526 Computer system
528 Memory
530 Memory area
532 Memory area
534 Memory area
536 Memory area
538 Memory area
540 Processor
542 Program
544 Program module
546 Network
548 Message
550 Electronic device
552 Memory
554 Memory area
555 Program
556 Memory area
558 Memory area
560 Memory area
562 Memory area
564 Memory area
566 Memory area
568 Program module
569 Processor
570 Program module
572 Program module
574 Message
576 Encrypted data
578 Interface
580 Client
582 Network interface
584 Processor
586 Program
588 Display
590 CAM
592 Processor
594 Program
596 Interface

1.-20. (canceled)

21. A method for determining a resulting chain of keys comprising the following steps:
determining a first chain of first keys, wherein a predecessor key can be calculated from each successor key of the first chain by applying a first function, wherein the first function is a one-way trapdoor function,
determining a second chain of second keys by iteratively applying a second function, wherein the second function is a one-way function,
wherein each key of the resulting chain can be determined from in each case a first key of the first chain and a second key of the second chain, and wherein the first chain is determined by iteratively applying an inverse function of the one-way trapdoor function by calculating a successor key from a predecessor key by applying the inverse function, and wherein a key of the resulting chain is determined by logic and arithmetic operations, which is carried out with the aid of at least one of the first keys and one of the second keys and is influenced by at least one further key.

22. The method according to claim 21, wherein the second function is a HASH function, an RSA operation, an operation of the Rabin method, or an operation of a method based on the discrete logarithm problem.

23. The method according to claim 21, wherein the execution of the first function presupposes the knowledge of a public key, and wherein the execution of the inverse function of the first function presupposes the knowledge of a private key.

24. The method according to claim 21, wherein the first function is the RSA operation (modular exponentiation) with a public key, and with a private key in the case of the inversion.

25. The method according to claim 21, wherein the first function is the operation of the Rabin method with a public key, and with a private key in the case of the inversion.

26. The method according to claim 21, wherein the first function is the operation of a method based on the discrete logarithm problem with a public key, and with a private key in the case of the inversion.

27. The method according to claim 21, wherein the key of the resulting chain is determined by one of the first and one of the second keys being attached to one another in pairs.

28. The method according to claim 21, wherein the key of the resulting chain is determined by applying a one-way hash function to at least one of the first keys and one of the second keys.

29. A method for transmitting a partial chain of a resulting chain of keys, wherein the resulting chain has been determined according to claim 21, and wherein the partial chain has a start key, and an end key and wherein a corresponding partial chain of the first chain and a corresponding partial chain of the second chain have been used for determining the partial chain, in the following steps:
transmitting an end key of the partial chain of the first chain,
transmitting a start key of the partial chain of the second chain.

30. The method according to claim 29, wherein the partial chain is lengthened by transmitting a further first key of the first chain, which lies in the first chain behind the previously transmitted end key.

31. The method according to claim 29, wherein transmitting the end key of the first chain and the start key of the second chain, or the further first key of the first chain, is effected via a network.

32. The method according to claim 29, wherein transmitting the end key of the first chain and the start key of the second chain, or the further first key of the first chain, is effected in an encrypted manner.

33. A non-transitory computer program product having computer-executable instructions for carrying out a method according to claim 21.

34. A computer system for determining a resulting chain of keys comprising
means for determining a first chain of first keys, wherein a predecessor key can be calculated from each successor key of the first chain by applying a first function, wherein the first function is a one-way trapdoor function, wherein the first chain is determined by iteratively applying an inverse function of the one-way trapdoor function by calculating a successor key from a predecessor key by applying the inverse function, and wherein a key of the resulting chain is determined by logic and arithmetic operations, which is carried out with the aid of at least one of the first keys and one of the second keys and is influenced by at least one further key,
means for determining a second chain of second keys by iteratively applying a second function, wherein the second function is a one-way function or a one-way trapdoor function,
wherein each key of the resulting chain can be determined from at least in each case a first key of the first chain and a second key of the second chain.

35. A computer system for transmitting a partial chain of a resulting chain of keys, wherein the resulting chain has been determined according to claim 21, and wherein the partial chain has a start key, and an end key and wherein a corresponding partial chain of the first chain and a corresponding partial chain of the second chain have been used for determining the partial chain, comprising means for transmitting the partial chain, wherein means for transmitting are designed for carrying out the following steps:
transmitting an end key of the partial chain of the first chain,
transmitting a start key of the partial chain of the second chain.

36. A method for receiving a partial chain of a resulting chain of keys, wherein the resulting chain has been determined according to claim 21, and wherein the partial chain has a start key and end key, comprising the following steps:
receiving one of the first keys of the first chain,
receiving one of the second keys of the second chain,
calculating first keys of a first partial chain of the first chain by iteratively applying the first function beginning with the received first key,
calculating second keys of a second partial chain of the second chain by iteratively applying the second function beginning with the received second key,
determining the partial chain of the resulting chain from the first and second partial chains.

37. The method according to claim 36, comprising the following further steps:
receiving a further one of the first keys of the first chain, which lies before the previously received first key,
calculating a lengthening of the first partial chain from the further first key by applying the first function,
calculating a lengthening of the second partial chain,
determining a lengthening of the partial chain of the resulting chain from the lengthenings of the first and second partial chains.

38. A computer program product having executable instructions for carrying out a method according to claim 36.

39. An electronic device for receiving a partial chain of a resulting chain of keys, wherein the resulting chain has been determined according to claim 21, and wherein the partial chain has a start key and an end key, and wherein a corresponding partial chain of the first chain and a corresponding partial chain of the second chain have been used for determining the partial chain, comprising
means for receiving one of the first keys of the first chain,
means for receiving one of the second keys of the second chain,
means for calculating first keys of the first partial chain of the first chain by iteratively applying the first function beginning with the received first key,
means for calculating second keys of the second partial chain of the second chain by iteratively applying the second function beginning with the received second key,
means for determining the partial chain of the resulting chain from the first and second partial chains.

40. The electronic device according to claim 39, wherein it is a computer system.

41. The electronic device according to claim 39, wherein it is a mobile device, a security token, in particular a USB stick, a smart card or an RFID tag.
